(19) United States
(12) Patent Application Publication
(10) Pub. No.: US 2013/0146602 A1
(43) Pub. Date: Jun. 13, 2013

(54) HYBRID CONTAINER

(71) Applicant: IPL, Inc., St-Damien (CA)

(72) Inventors: Claude Lessard, Levis (CA); Louis Mercier, Levis (CA); Shaun Carvey, Clifton Park, NY (US); Marc Talbot-Pouliot, Sain-Lazare-De-Bellechasse (CA); Roch Nolet, St-Joseph (CA); Jean Pierre Emond, Tampa, FL (US); Melissa Ann Germain, Tampa, FL (US)

(73) Assignee: IPL, Inc., St-Damien (CA)

(21) Appl. No.: 13/709,910

(22) Filed: Dec. 10, 2012

Related U.S. Application Data
(60) Provisional application No. 61/568,370, filed on Dec. 8, 2011.

(51) Int. Cl. B65D 25/14; B31B 7/00

(52) U.S. Cl. CPC B65D 25/14; B31B 7/00
USPC 220/495.04; 220/495.01; 493/93

(57) ABSTRACT

A container comprising a base, first opposed side walls and second opposed side walls, wherein at least one of the base and side walls comprises a combination of a frame part and a liner part, the frame part forming between about 10% and 100% of a surface of the at least one of said base and opposed side walls. The present container allows air flow within the container and a minimised weight, while achieving a target resistance in torsion and compression, and a customized physical protection of the goods intended to be packed and handled therein.

### CROSS REFERENCE TO RELATED APPLICATIONS

This application claims benefit of U.S. provisional application Ser. No. 61/568,370, filed on Dec. 8, 2011. All documents above are incorporated herein in their entirety by reference.

### FIELD OF THE INVENTION

The present invention relates to a lightweight sturdy reusable container. More specifically, the present invention is concerned with an hybrid container.

### BACKGROUND OF THE INVENTION

Containers for handling food products, or produce such as containers for bananas as illustrated example in FIGS. 1 and 2 for example, are typically corrugated board boxes. Such containers, designed to support a weight of about 40 pounds, have typically a weight around 2.7 pounds when empty.

The total weight of containers and content thereof is of concern since transportation regulations may restrict a total weight of transportation vehicles.

Another concern when dealing with goods such as fragile items for example is conservation and proper handling until delivery to end distributors and end consumers.

There is still a need in the art for a lightweight sturdy container.

### SUMMARY OF THE INVENTION

More specifically, in accordance with the present invention, there is provided a container comprising a base, first opposed side walls and second opposed side walls, wherein at least one of the base and side walls comprises a combination of a frame part and a liner part, the frame part forming between about 10% and 100% of a surface of the at least one of said base and opposed side walls.

There is further provided a method for making a container comprising a base, first opposed side walls and second opposed side walls, comprising selecting, for at least one of the base and side walls, a frame part and a liner part, the frame part forming between about 10% and 100% of a surface of the at least one of the base and side walls.

There is further provided a method for making a container comprising a base, first opposed side walls and second opposed side walls, comprising forming each one of the base and side walls with at least one of a frame part and a liner part, the frame part of the base being up to about 86% open, the frame part of the side walls being up to about 63% open, the liner part of the base being up to about 23% open, the liner part of the side walls being up to about 24% open.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a view of a stack of containers on a pallet as known in the prior art;

FIG. 2 shows a container as known in the prior art;

FIG. 3 is a perspective view of a container according to an embodiment of an aspect of the present invention;

FIG. 4 is a perspective view of a frame of a container according to an embodiment of an aspect of the present invention;

FIG. 5 is a perspective view of a frame of a collapsible container according to an embodiment of an aspect of the present invention, in a collapsed position;

FIG. 6 is an exploded view of a container according to an embodiment of an aspect of the present invention;

FIG. 7 is a perspective view of a container according to an embodiment of an aspect of the present invention without lid liner;

FIG. 8 is an exploded view of a container according to an embodiment of an aspect of the present invention;

FIG. 9 is a perspective view of a container according to an embodiment of an aspect of the present invention;

FIG. 10 is a perspective view of a frame of a container according to an embodiment of an aspect of the present invention;

FIG. 11 is a perspective view of a frame of a collapsible container according to an embodiment of an aspect of the present invention, in a collapsed position;

FIG. 12 is an exploded view of a container according to an embodiment of an aspect of the present invention;

FIG. 13 is a perspective view of the container of FIG. 12;

FIG. 14 is a perspective view of a frame of a container according to an embodiment of an aspect of the present invention;

FIG. 15 shows a frame of a container according to an embodiment of an aspect of the present invention;

FIGS. 16 show a) a base liner for a collapsible container b) a base liner for a non-collapsible container, and c) a lid liner, according to embodiments of an aspect of the present invention;

FIG. 17 is an exploded view of a base line of a container according to an embodiment of an aspect of the present invention;

FIGS. 18a-f show details of a container according to an embodiment of an aspect of the present invention;

FIGS. 19 show a) vibration tests results on corrugated containers of the prior art and on containers of the present invention filled with bananas; b) temperature across a pallet of stacked containers of the prior art containing bananas and c) temperature across a pallet of stacked containers of the present invention with a same load.

### DESCRIPTION OF EMBODIMENTS OF THE INVENTION

A container generally comprises a base and side walls. A container of the present invention selectively combines a frame and a liner to form each one of the container's surfaces, i.e. the base and side walls, in such a way as to allow air flow within the container and minimise the weight of the container, while achieving a target resistance of the container in torsion and compression, and a customized physical protection of the goods intended to be packed and handled therein.

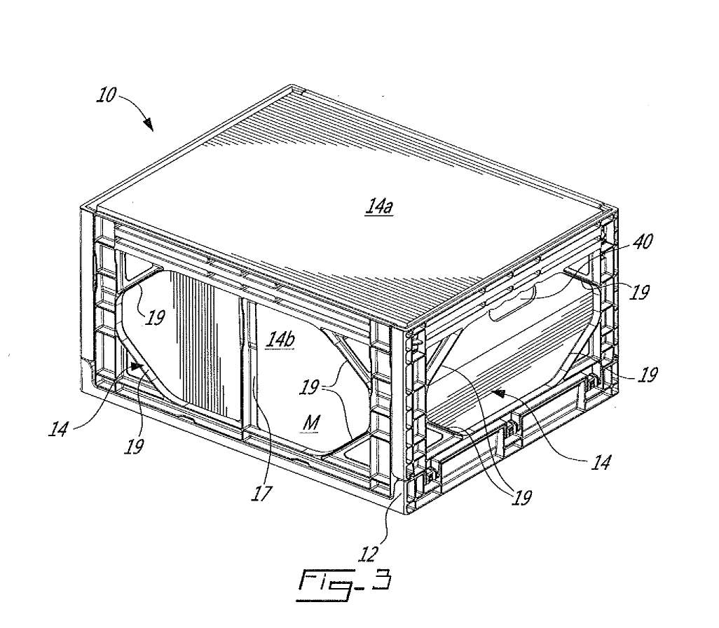

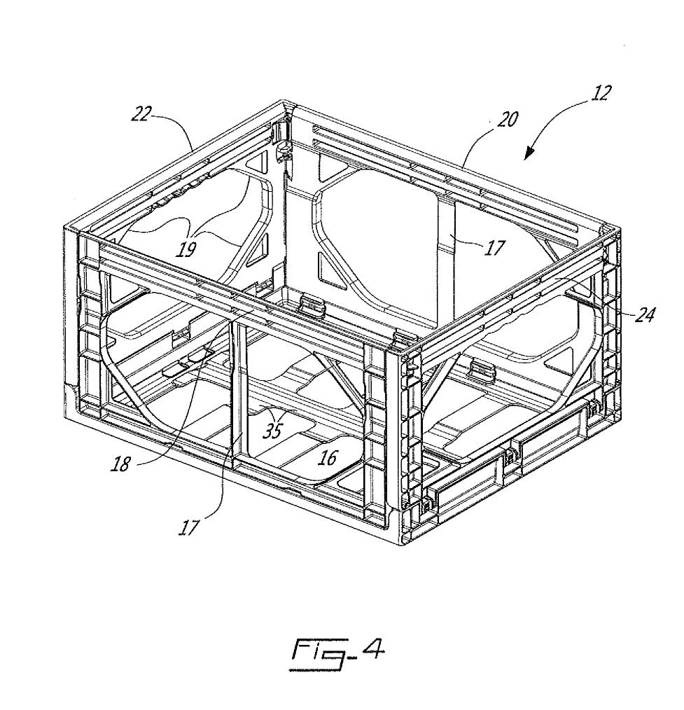

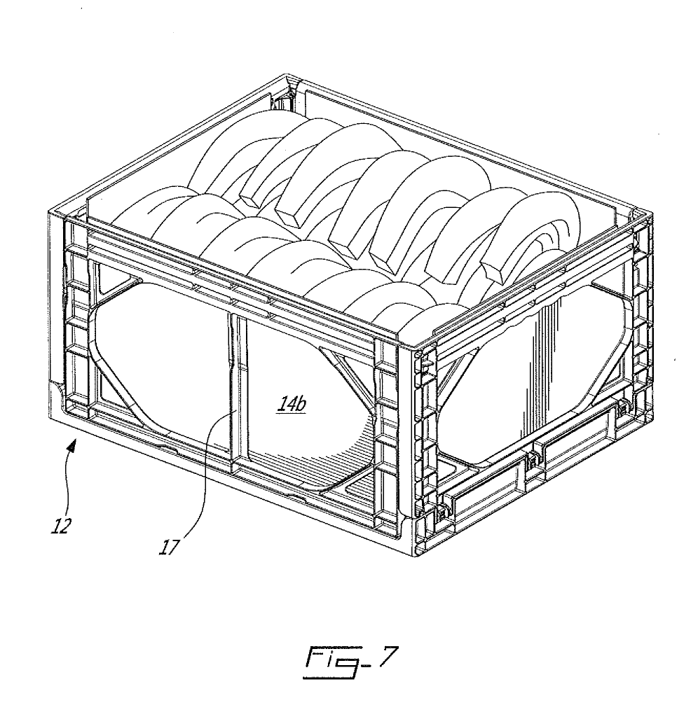

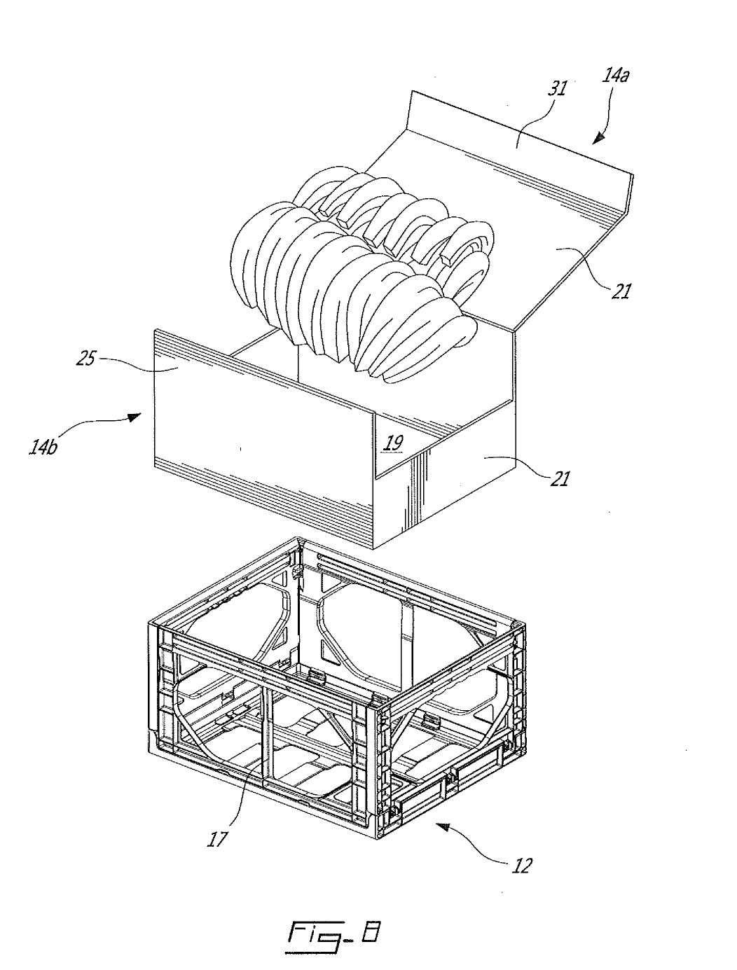

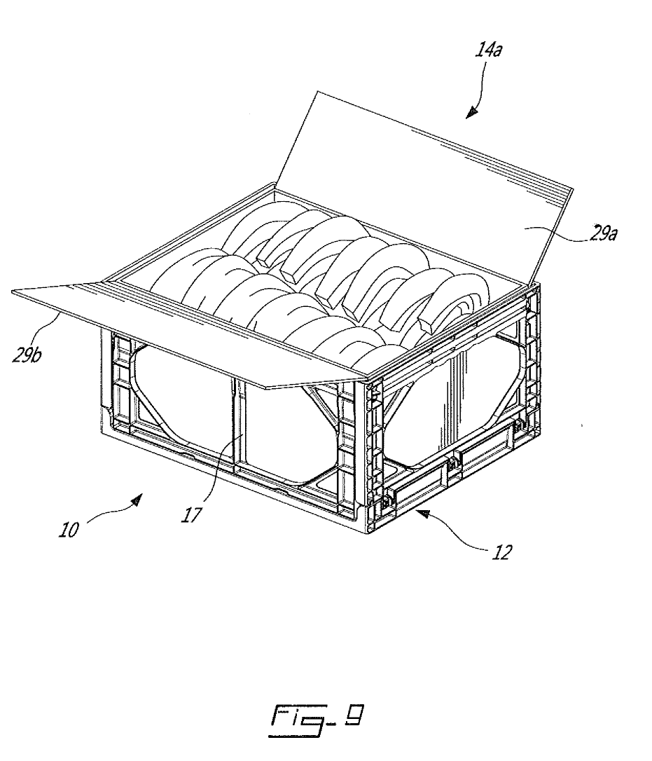

In embodiments illustrated in FIGS. 3-14 for example, the frame 12 comprises a base 16, long side walls 18, 20 and short side walls 22, 24. The base 16 and the side walls 18, 20, 22, 24 may be injected plastic parts, They may be in other rigid light materials, such as composites or aluminum for example.

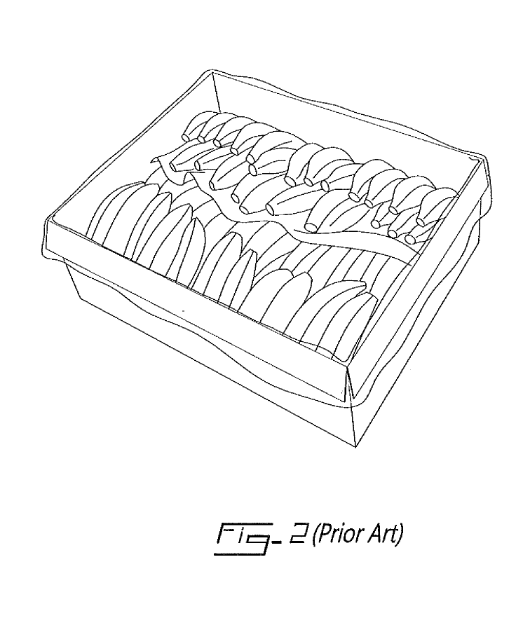

Each side wall comprises a pair of opposed short edges and a pair of opposed long edges. Ribs 17 may be provided between opposed edges, for example between opposed long edges of the long side walls 18 and 20 as illustrated in FIGS. 3-9 for reinforcement and/or to prevent the content within the container from protruding out of the container for example, Corner ribs 19 connecting adjacent edges of a side wall, as illustrated in FIGS. 2 and 3, are found to increase resistance in torsion of the frame. In FIG. 14, corner ribs 19 are provided on the short walls 22, 24, and lateral ribs 21 are added between the opposed long edges at lateral ends of the long walls 18, 20, to increase resistance in torsion of the frame. Corner ribs 19, lateral ribs 21, and ribs 17 as described hereinabove are also found to support the liner 14. Corner ribs 19 and lateral ribs 21 allow an unobstructed view on the liner 14.

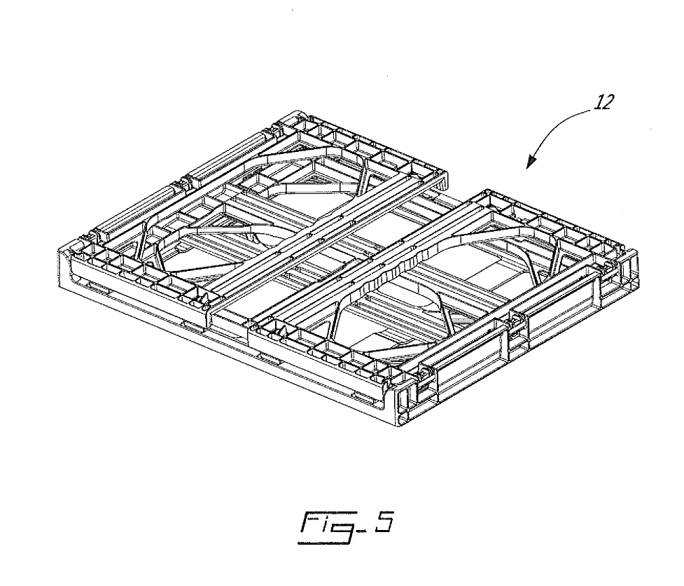

As shown in FIGS. 4-6, 8, 10-12 and 14-15, the frame base 16 comprises a pair of opposed short edges and a pair of opposed long edges. The base 16 may comprise an open grid 35 of ribs between the opposed edges, as illustrated for example in FIGS. 4-6, 8, 10-12 and 15. in FIG. 14, the frame base 16 is shown with lateral opposed lateral long and short edges only, delimiting an open surface, at least ones of the opposite lateral long edges and short edges having an inner rim 13 directed toward the center of the frame base to support a liner. In the case of a frame base of a surface of 16×20cm for example, such a circumferential rim 13 may have a width toward the center of the base 16 of about 2 to 3 cm for example.

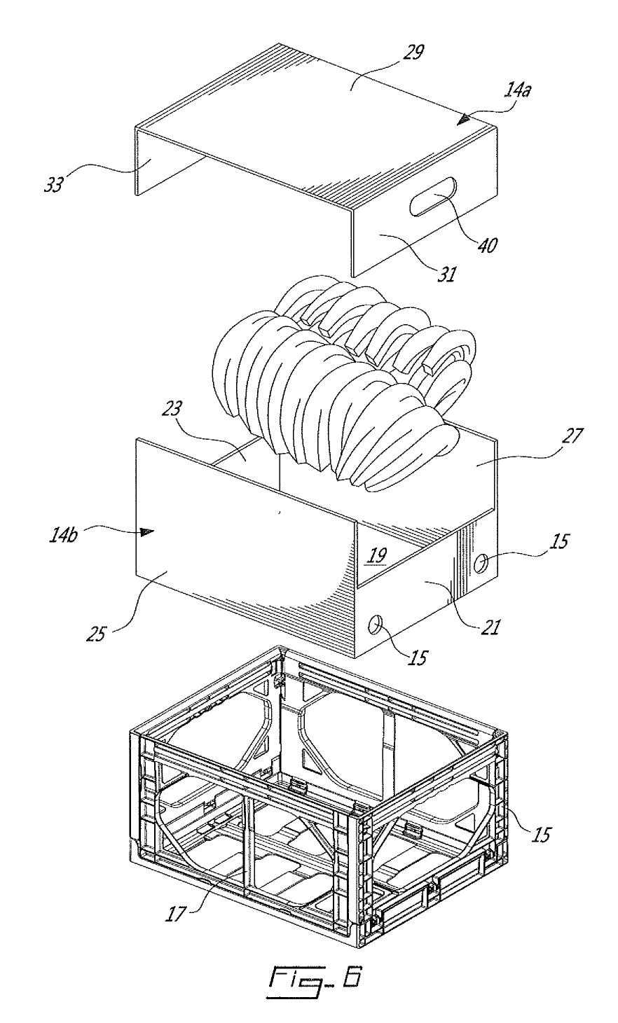

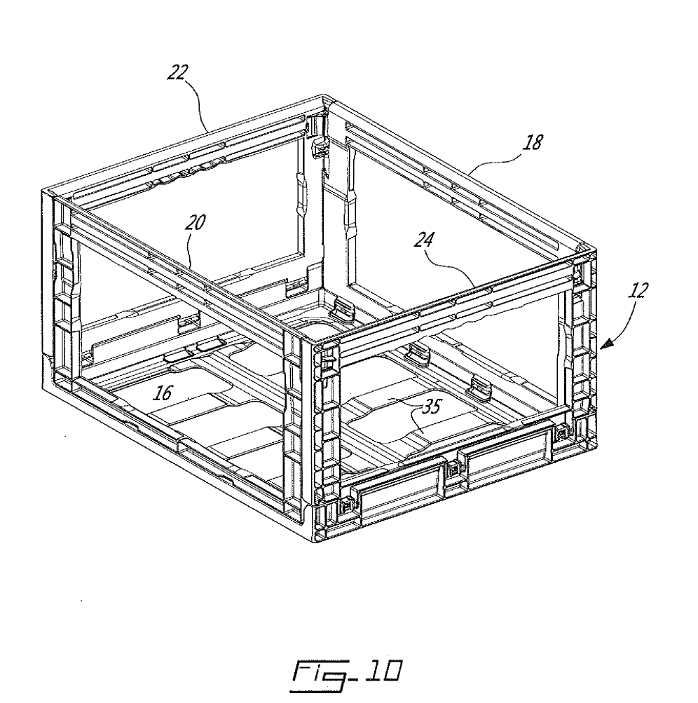

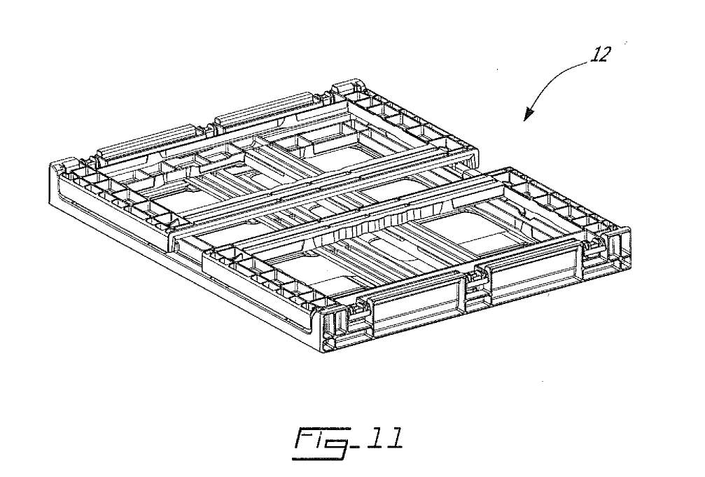

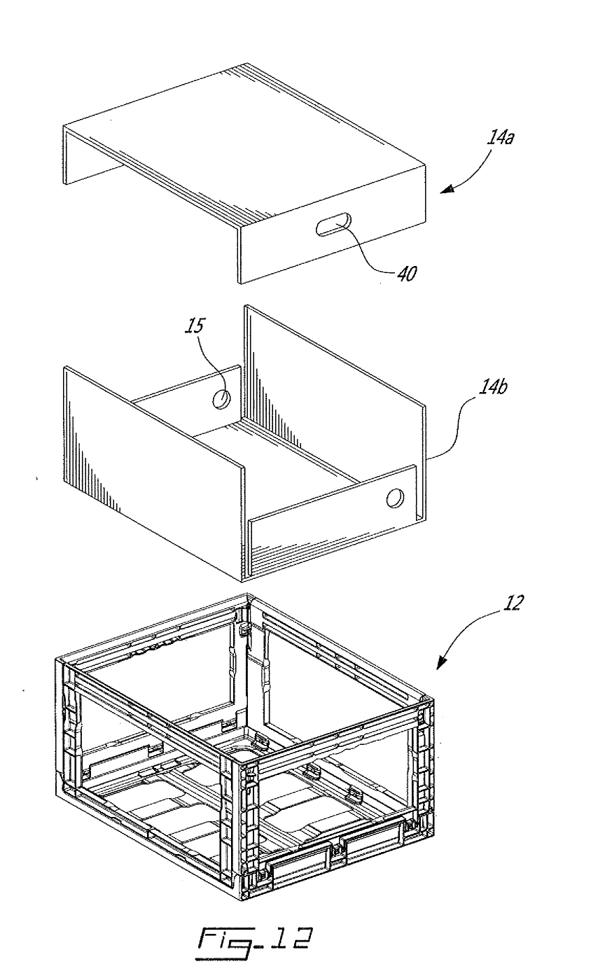

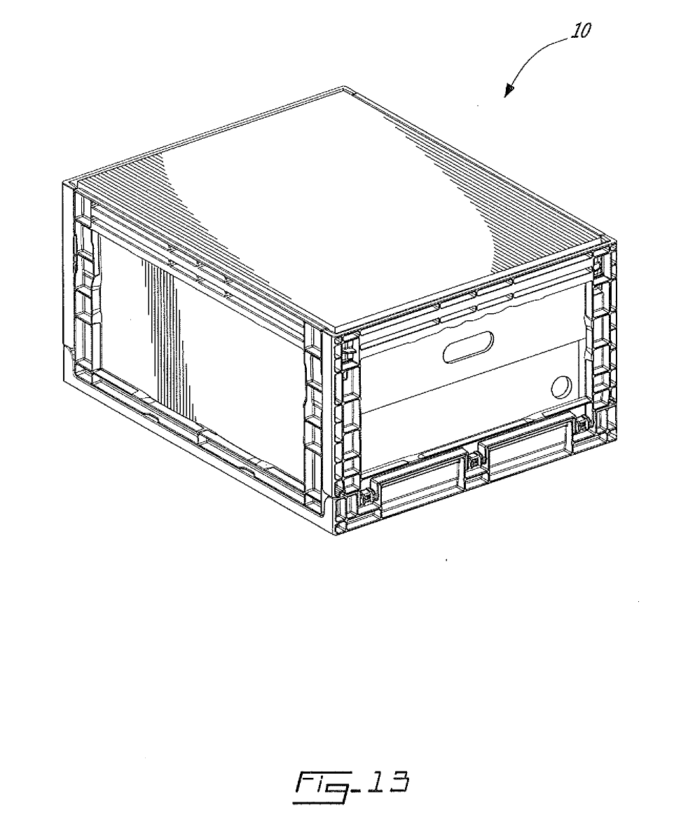

The frame side walls 18, 20, 22, 24 may be pivotally connected to the frame base 12 so as to be pivotally moved between two positions including an erected position (see FIGS. 4 and 10) in which the side walls stand up from the base 16, and a non-erected, collapsed position (see FIGS. 5 and 11), thereby providing a collapsible frame. When the container 10 is not in use, it may thus be folded to a collapsed position, either with the liner 14 in position or at least partly removed.

The frame 12, when in an erected position shown for example in FIGS. 4 and 11 in case of a collapsible frame, is rigid enough to provide mechanical resistance to the container 10, for holding a load it is intended to, and to withstand torsional forces for example when the container 10 with goods therein is carried.

The liner 14 is selected depending on the frame 12 to achieve a customized container, in terms of air flow within the container and/or cushioning of the goods to be packed and handled within the container. The liner is selected to cover at least part of one surface of the frame 12. The liner may have a varying thickness on different surfaces of the container.

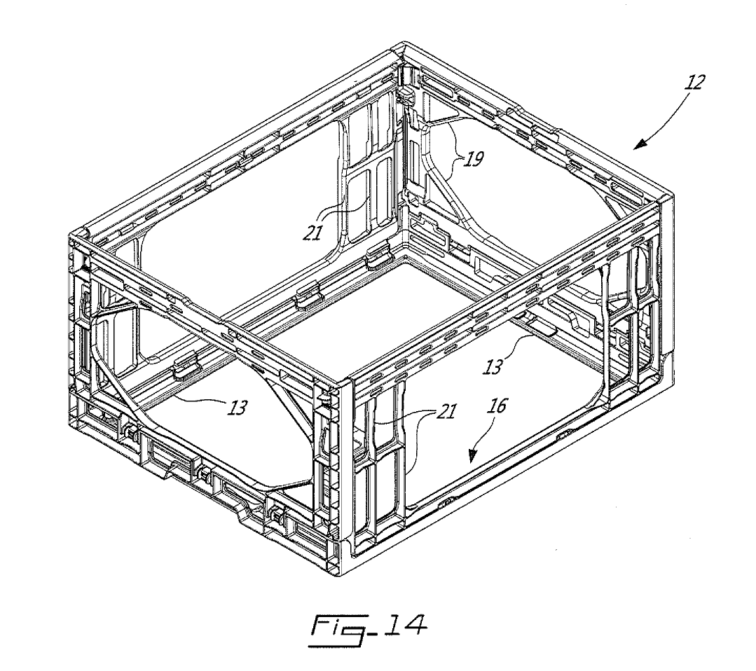

The liner 14 may comprise a base liner 14b adapted to be received within the frame 12, and a lid liner 14a for example. In an embodiment illustrated in FIGS. 6, 12 and 16, the base liner 14b comprises a base 19, short side walls 21, 23 and long side walls 25, 27 extending up from the base 19 in an erected position; and the lid liner 14a comprises a top surface 29 and opposite side walls 31, 33 extending therefrom (long side walls 31, 33 in FIG. 16c; short side walls in FIGS. 6 and 12). FIG. 16a shows a base liner with angled transitions between adjacent side walls.

In an embodiment illustrated in FIG. 8, the base liner 14b comprises a base 19, short side walls 21, 23 and long side walls 25, 27 extending up from the base 19 in an erected position, and the lid liner 14a comprises a top surface 29 and a long side wall extending therefrom along a longitudinal edge of the top surface 29, the lid liner 14a being an extension of the base liner 14b, foldingly connected along its opposite long edge to the edge of one of the long side walls 25, 27 of the base liner 14b.

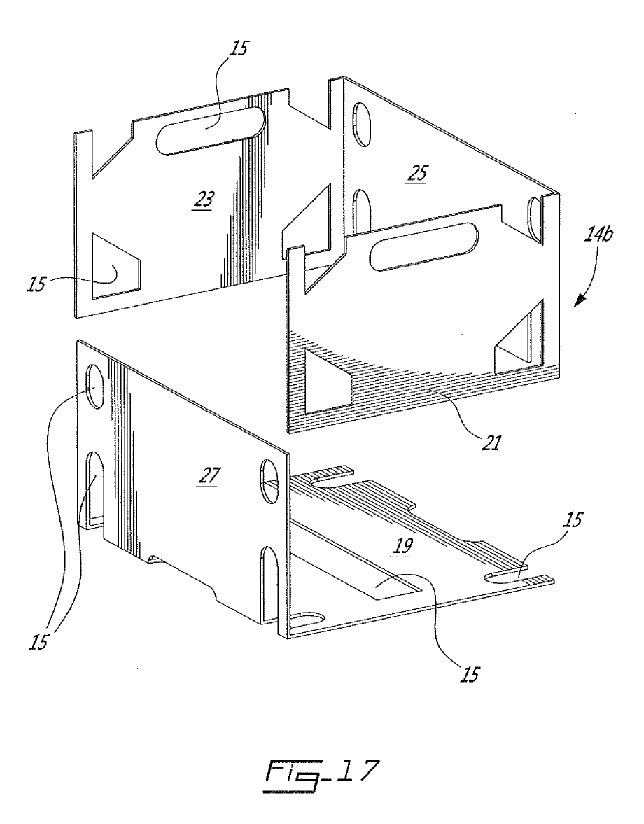

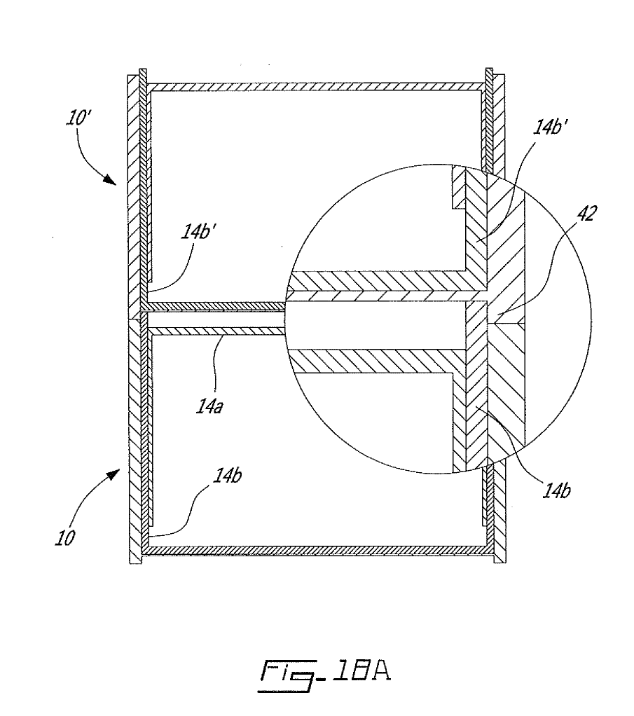

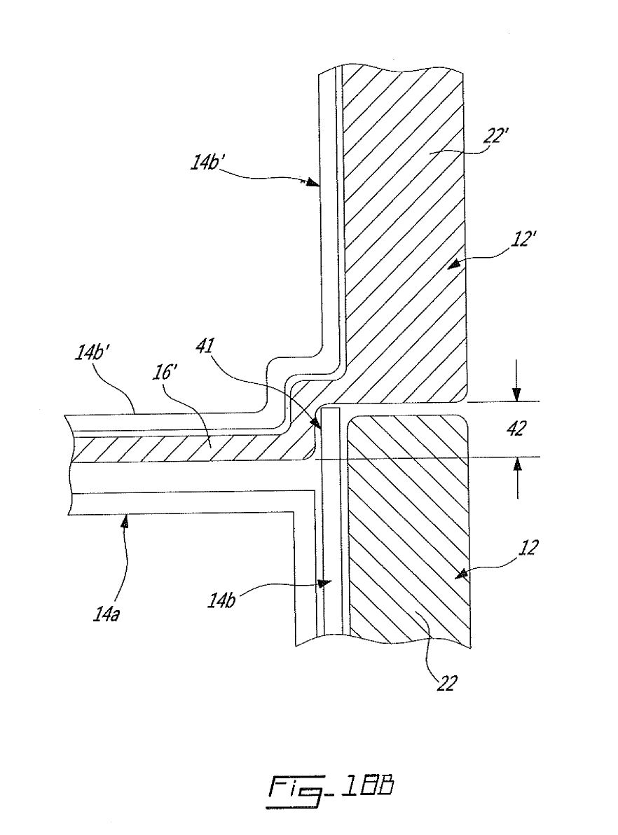

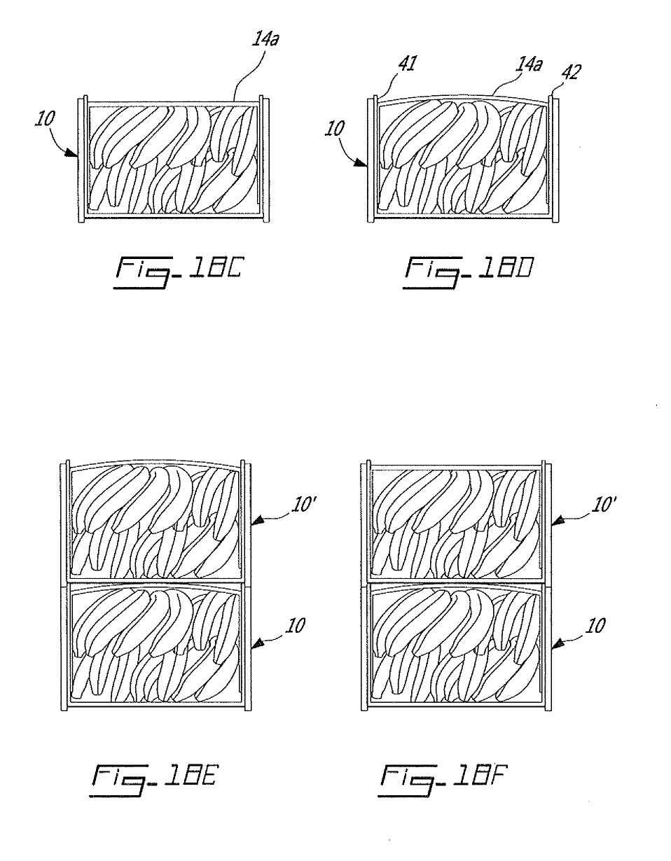

As shown for example in FIG. 17, the base liner 14b may be a multiple pieces liner.

In an embodiment illustrated in FIG. 9, the lid liner 14a comprises a two-pieces top surface, each part 29a, 29b being foldingly connected along a respective edge of opposite side walls of the base liner 14b, for example the long side walls 25, 27.

The liner 14 may be cut out of corrugated board sheets, or plastic sheets such as corrugated plastic sheets for example, foam sheets or metal sheets for example. The material of the liner 14 may be selected to be impermeable or to let air go though, and/or to be watertight. The liner 14 may be freely received within the frame, or secured thereto, by clipping for example or otherwise.

The liner 14 may be provided with an adaptable pattern of ventilation apertures depending on the intended use, depending on the frame 12 it is combined with, to create a target air flow path through the container, for example by providing apertures 15 as illustrated in FIGS. 6, 12, 16 and 17. In case of produce, such as bananas for example, a venting pattern comprising a vent 15 placed in each corner of the liner 14 as shown in FIGS. 16 and 17, where the packing of produce leaves an opening for air to flow through the container, is found to optimise airflow and temperature uniformity within the container, in particular when containers are stacked on a pallet.

The liner 14 covers at least some of the openings, i. e. open surfaces, of the base and side walls of the frame 12, so as to hold the content of the container 10 within and/or for preventing access to the inside of the container 10. As mentioned hereinabove, some openings of the base and side walls of the frame 12 may be left uncovered, and/or some parts of the liner 14 may be provided with vents, for ventilation purposes for example.

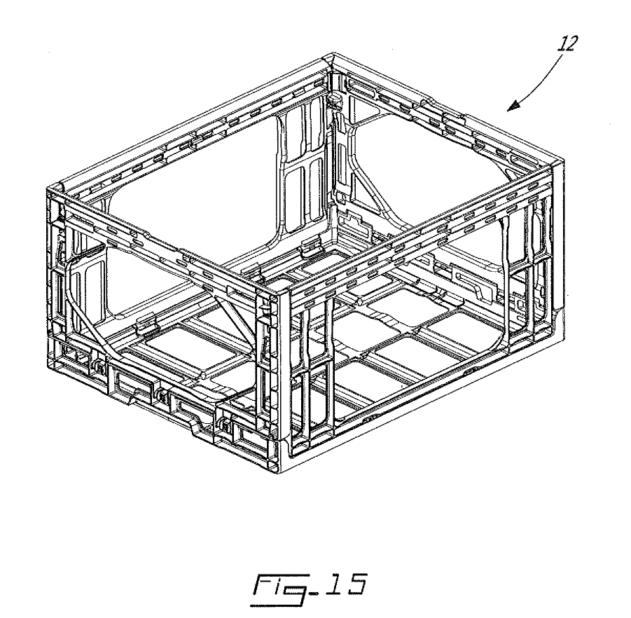

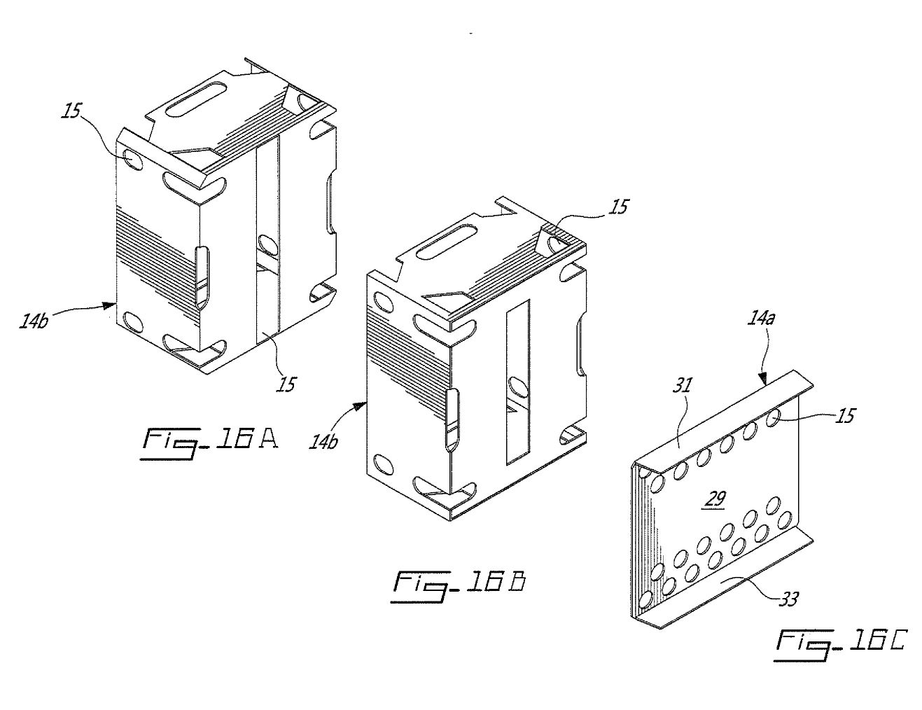

A 3-side lid liner 14a as shown in FIGS. 6 and 12 for example is found to contribute to the overall resistance of the container in torsional deformation force that may occur when the container 10 with good therein is carried, by handles 40 on the short side walls or example, by locking the four side walls of the frame 12 together (see FIGS. 3 and 13).

In FIGS. 6, 7 and 13 for example, the base liner 14b, comprising a base, opposite long side walls and opposite short side walls, the side parts standing up from the base 19 in an erected position, is received within the frame 12, its base 19 supported by the base 16 of the frame 12 thereby lining the inside of the frame 12 and protecting the goods within the container from the outside.

FIG. 15 illustrates a frame comprising an open grid of ribs between opposed edges as a base, long side walls and short side walls, each side wall comprising a first pair of opposed edges and a second pair of opposed edges delimiting an open surface, corner ribs 19 being provided on the short walls 22, 24, and lateral ribs 21 being added between the opposed long edges at lateral ends of the long side walls 18, 20. In such a frame, each short side walls is more than 50% open, for example 59.4% open, i.e, devoid of material, each long side wall is more than 60% open, for example 62.39% open, i.e. devoid of material and the base is more than 50% open, for example 53.5% open, i.e. devoid of material. A base 16 as illustrated in FIG. 14 is more than 80% open, for example 86.49% open, i.e. devoid of material. The percentages are in terms of surfaces of the base and side walls.

The frame of FIG. 15 may be combined with a liner as illustrated in FIG. 16b for example, which long side walls are about 11.6% open and short side walls are about 24.81% open due to openings 15; the base of such liner being about 23.65% open. Such combination provides a sturdy, lightweight five-side container, including base and side walls, able to hold goods therein while allowing air to flow therethrough, and also allowing air to flow between containers in a stack of a plurality of such containers.

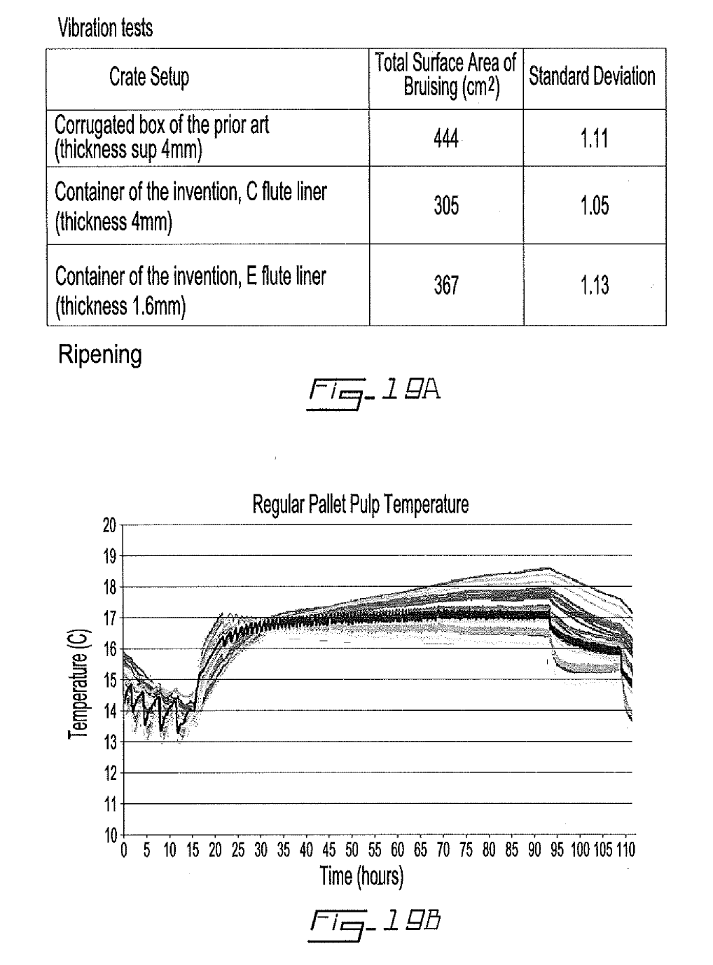

The liner 14 contributes to the resistance of the container 10 in compression, as described hereinbelow in relation to FIG. 18.

At least part of the liner 14 is removable, so that it can be removed, discarded and replaced if needed.

As the liner provides an interface between the frame 12 and the content of the container, the liner protects the frame from being dirty too quickly, hence a reduced washing cycle for the frame. The liner 14 it may be removed and discarded if soiled and/or damaged.

A corrugated board liner for example is found to provide rigidity in compression. Moreover, the liner may be cut out considering the orientation of the flutes in the corrugated board for enhanced rigidity.

The liner 14 can be treated with chemicals depending on the application for the container, for example to prevent insect or bacterial contamination.

FIGS. 18a, 18b, 18e and 18f show two containers 10 and 10′, of respective frame 12 and 12′ (base 16, 16′, side walls 22, 22′), respective base liner 14b, 14b′, respective lid liner 14a, 14a′, stacked one on top of the other. The base 16′ is connected to the side wall 22′ by an offset 42. This offset 42 is adapted to receive the top edge of the side wall 22 and the liner 14b of the container 10 positioned below, thereby locking the stacked containers 10 and 10′ together. Such offset 42 also provides tolerance for sag caused by the load of the content in the container 10′ (see FIG. 18c). Extensions 41 of the liner 14b may also provide a protection from bulging of the lid liner 14a (see FIGS. 18d-18d).

The liner 14 provides cushioning, shielding the goods within the container from vibrations and friction for example, as compared with an all plastic container.

The liner 14 provides surfaces for applying a company's brand or other advertising message (M) (see FIG. 3) or required information, without the need for an extra label for example.

Moreover, if needed, the liner 14 allows accessing the inside of the container, by cutting it, to remove an item for inspection or quality check by removing a sample for example.

The liner contributes to the resistance of the container to torsional deformation force that may occur when the container 10 is carried, by handles 40 on the short sides for example, by locking the sides of the frame 12 together.

The present container may be delivered in a harvest field or a packing house for example with the frame 12 folded in a collapsed position as shown in FIGS. 5 and 11, in case of a collapsible container. The frame only needs be erected (see FIGS. 4 and 10) if collapsible and the base liner position therein. Perforated sheets, such as a plastic sheet and a kraft paper sheet for example, in case of a container used for produce such as bananas for example, may be then laid down over the liner, as standardly done in the art, before the bananas are put in the container. Then a lid liner is positioned, thereby locking the container shut. The container, when needed for inspection, display or sale of the content, is rapidly and easily opened by removing the lid liner.

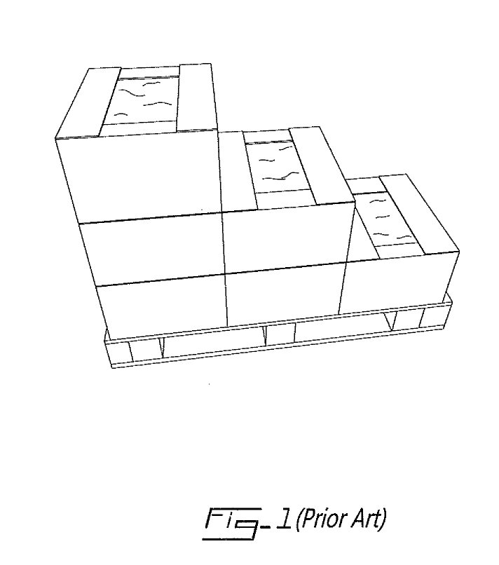

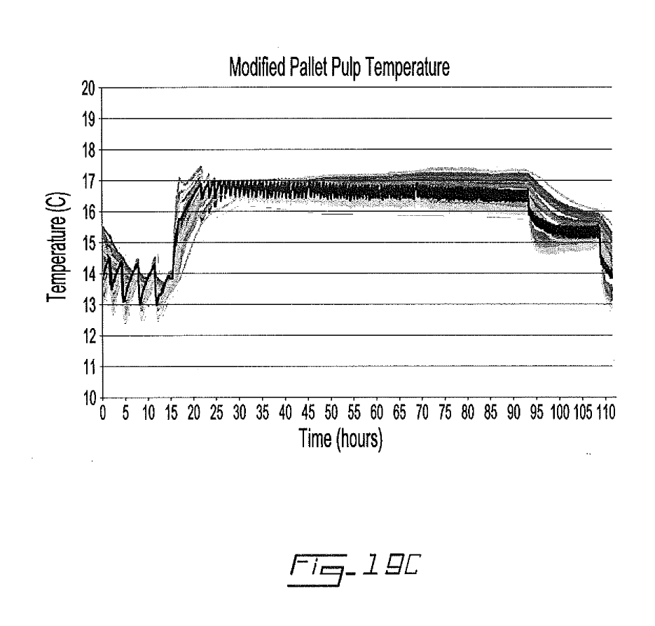

It is found that handling goods such as bananas for example, from their harvest place in containers of the present invention, typically stacked on pallets, yields an improved quality of the delivered goods, in terms of less bruise and crown damages caused by compression and vibration during transportation. Tests simulating vibrations occurring during transportation of bananas showed that containers of the present invention comprising a polypropylene frame and a “C flute” corrugated board liner reduced the occurrence of bruises by as much as 33% compared to standard corrugated board containers as illustrated in FIGS. 1 and 2 (see FIG. 19a).

Moreover, the present containers is shown to allow an efficient air flow about the goods, within each container of a stack of containers and through the stack itself, resulting, in case of bananas for example in a more consistent color and improved control of the temperature across a pallet supporting stacked containers (see FIGS. 19b, 19c). For bananas for example, it is measured that the ripening time is significantly decreased. Simulations have shown that the time required to heat up or cool down the load during the ripening process, when using containers of the present invention, is about 5 hours compared to 24 hours for a typical corrugated board container of the prior art.

The present container is a lightweight, sturdy, reusable hybrid container, which may be collapsible. For example, a container of the present invention may comprise a corrugated board liner of 0.6 pound, which is almost 80% of the weight of a standard corrugated board container as shown in FIGS. 1 and 2.

It is found that the present combination of a frame part and a liner part allows using a frame part with surfaces up to about 90% open (i.e. open, devoid of material). Thus the present container comprising a base, first opposed side walls and second opposed side walls, comprises at least one of this base and side walls as a combination of a frame part and a liner part, the frame part forming between about 10% and 100% of a surface of the at least one of the base and opposed side walls.

As people in the art will appreciate, the present invention provides a customized container of reduced weight while having a good resistance to impact and mechanical resistance under load, as well as rigidity and structural stability when carried or stacked, The present container, although lightweight, is resistant to torsional deformation and compression.

With the same footprint as a container as used in the art (see FIGS. 1 and 2), which allows using standard packing methods and equipment and the same truck load layout, the present container has a similar weight and is reusable. The container of the present invention uses less corrugated board, i.e. for example up to 50% less (see FIGS. 1 and 2), for example up to 80% less, than a container as known in the art.

Moreover, the present container is easily and quickly assembled, and erected if collapsible, with no need of gluing parts as is required with standard containers of the prior art as shown in FIGS. 1 and 2.

In contrast to corrugated board containers as known in the art (see FIGS. 1 and 2) where provision of ventilation apertures is limited since they may jeopardise the resistance in compression and torsion of the containers, the present container allows customized and optimised patterns of ventilation apertures.

The present container can be tailored according to specific applications. It is reusable.

Although the present invention has been described hereinabove by way of embodiments thereof, it may be modified, without departing from the nature and teachings of the subject invention as described herein.

1. A container comprising a base, first opposed side walls and second opposed side walls, wherein at least one of said base and side walls comprises a combination of a frame part and a liner part, said frame part forming between about 10% and 100% of a surface of said at least one of said base and opposed side walls.

2. The container of claim 1, wherein said frame part and said liner part are combined to form apertures for air flow through the container.

3. The container of claim 1, wherein said frame part and said liner part are combined to provide protection of goods intended to be handled within the container against physical damage.

4. The container of claim 1, wherein the frame part of said base forms about 10% of a surface of said base and the frame part of said side walls forms about 37% of a surface of said side walls.

5. The container of claim 1, wherein the frame part of the base is up to about 86% open, the frame part of the side walls is up to about 63% open, the liner part of the base is up to about 23% open, the liner part of the side walls is up to about 24% open.

6. The container of claim 1, wherein said frame part is in one of plastic, composites and aluminum, and said liner part is in one of corrugated board, plastic and foam.

7. The container of claim 1, wherein said frame parts and said liner parts form vents for air flow through the container.

8. The container of claim 1, wherein said side walls are pivotally connected to the base so as to be pivotally moved between an erected position and a folded position of the container.

9. The container of claim 1, wherein the frame part of said base comprises first opposed edges and second opposed edges delimiting an open surface, at least ones of the first and second opposed edges having an inner rim.

10. The container of claim 1, wherein the frame part of said base comprises first opposed edges, second opposed edges, and an open grid of ribs between opposed edges.

11. The container of claim 1, wherein the frame part of said side walls comprises first opposed edges and second opposed edges delimiting an open surface.

12. The container of claim 1, wherein the frame part of said side walls comprises first opposed edges and second opposed edges delimiting an open surface, and at least one of: i) at least one corner rib connecting adjacent edges of a side wall; and ii) at least one rib between opposed edges of a side wall.

13. The container of claim 1, wherein the liner part of said base and the liner part of said side walls is a one-piece liner.

14. The container of claim 1, wherein the liner part of said base and the liner part of said side walls is a multiple-piece liner.

15. The container of claim 1, wherein said liner part is removable.

16. The container of claim 1, further comprising a lid liner.

17. The container of claim 1, wherein said frame part of the base is connected to the frame part of the side walls by an offset.

18. The container of claim 1, wherein said frame part of said side walls is pivotally connected to said frame part of said base.

19. A method for making a container comprising a base, first opposed side walls and second opposed side walls, comprising selecting, for at least one of the base and side walls, a frame part and a liner part, the frame part forming between about 10% and 100% of a surface of the at least one of the base and side walls.

20. The method of claim 19, comprising combining the frame part and the liner part to create an air flow path through the container.

21. The method of claim 19, comprising selecting a frame part up to about 86% open and a liner part up to about 23% open for the base, and a frame part up to about 63% open and a liner part up to about 24% open for the side walls.

22. The method of claim 19, comprising:
selecting for the side walls a frame part comprising first opposed edges and second opposed edges delimiting an open surface, and at least one of: i) at least one corner rib connecting adjacent edges of a side wail; and ii) at least one rib between opposed edges of a side wall; and
selecting for the base a frame part comprising first opposed edges and second opposed edges delimiting an open surface, and at least one of: i) an inner rim on at least ones of the first and second opposed edges and ii) an open grid of ribs between opposed edges.

23. A method for making a container comprising a base, first opposed side walls and second opposed side walls, comprising forming each one of the base and side walls with at least one of a frame part and a liner part, the frame part of the base being up to about 86% open, the frame part of the side walls being up to about 63% open, the liner part of the base being up to about 23% open, the liner part of the side walls being up to about 24% open.

24. The method of claim 23, comprising combining the frame parts and the liner parts to form an air flow path through the container.

25. The method of claim 23, comprising forming the frame part of one of plastic, composite and aluminum, and forming the liner part in one of corrugated board, plastic and foam.

26. The method of claim 23, comprising pivotally connecting the frame part of the side walls to the frame part of the base.

27. The method of claim 23, comprising forming the liner part of the base and the liner part of the side walls as a one-piece liner.

28. The method of claim 23, comprising forming the liner part of the base and the liner part of the side walls as a multiple-piece liner.

29. The method of claim 23, comprising forming the liner part with an extension for a lid liner.
